(19) United States
(12) Patent Application Publication
(10) Pub. No.: US 2024/0154465 A1
(43) Pub. Date: May 9, 2024

(54) TRANSPARENT ANTENNAS FOR WIRELESS CHARGING

(71) Applicant: Meta Platforms Technologies, LLC, Menlo Park, CA (US)

(72) Inventors: John Ho, Sunnyvale, CA (US); Yasuo Morimoto, Cupertino, CA (US); Boon Shiu, Palo Alto, CA (US); Wei Huang, San Diego, CA (US); Jiang Zhu, Cupertino, CA (US)

(21) Appl. No.: 18/487,313

(22) Filed: Oct. 16, 2023

Related U.S. Application Data
(60) Provisional application No. 63/383,048, filed on Nov. 9, 2022.

(51) Int. Cl. H02J 50/20; G02B 27/01; H01Q 1/27; H01Q 1/38

(52) U.S. Cl. CPC H02J 50/20; G02B 27/0172; H01Q 1/273; H01Q 1/38; G02B 2027/0178

(57) ABSTRACT

The present disclosure is generally directed to systems and devices for wirelessly transferring electrical power. In one scenario, a system is provided that may include a substrate and a transparent conductive material disposed on at least a portion of the substrate. The transparent conductive material may include electrical traces formed into the material, and those electrical traces may be configured to conduct electrical power. The electrical traces are shaped into antennas that are configured to wirelessly transfer or receive electrical power. Other mobile electronic devices and apparatuses are also provided.

### CROSS-REFERENCE TO RELATED APPLICATIONS

This application claims priority to and the benefit of U.S. Provisional Patent No. 63/383,048, filed on Nov. 9, 2022, which application is incorporated by reference herein in its entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an example pair of augmented reality glasses that may include one or more antennas formed within a transparent conductive material.

FIG. 2 is an illustration of an alternative example pair of augmented reality glasses that may include one or more antennas formed within a transparent conductive material.

FIG. 3 is an illustration of an example portion of conductive mesh having a specific pitch and width.

FIGS. 4A-4C are illustrations of different embodiments in which conductive and non-conductive portions of a transparent material are implemented on a surface of an electronic device.

FIG. 5 is an illustration of an alternative example pair of augmented reality glasses that may include one or more antennas formed within a transparent conductive material.

FIG. 6 is an illustration of a system in which power is wirelessly transferred from a transmitter to a receiver through transparent or opaque antennas.

FIG. 7 is an illustration of exemplary augmented-reality glasses that may be used in connection with embodiments of this disclosure.

FIG. 8 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to improved methods of wireless charging that may be applied to mobile electronic devices including augmented reality (AR) devices, virtual reality (VR) devices, smartwatches, mobile phones, and other electronic devices that are capable of implementing wireless charging. In some systems, wireless charging units have used thick coils of wire to create inductive receivers that would receive power from corresponding transmitters through a near-field coupling. In other cases, wireless charging systems would use antennas or arrays of antennas whose individual dimensions and spacing were comparable to half of the wavelength used to receive power from transmitters through far-field radiation. In both cases, the resulting inductive coils and antennas would take up a great deal of space and would add considerable heft to otherwise lightweight mobile devices.

The embodiments described herein provide wireless charging for electronic devices using antennas that are formed within a transparent conductor. The transparent conductor may be applied to a mobile device's exterior (e.g., to the lenses of AR glasses or to the display of a smartwatch). In some cases, the transparent conductor may include a transparent conductive mesh. The transparent conductive mesh may provide a large surface area that enables higher efficiency charging, longer charging range, and greater robustness to misalignment between transmitter and receiver. Moreover, at least in some embodiments, by selectively removing the connectivity of specific regions of the transparent mesh, both near- and far-field wireless charging may be provided. Still further, because the charging antennas may be formed using transparent conductive mesh, the charging antennas may add very little weight to the mobile devices on which they are used. Other types of transparent conductors may also be used including indium tin oxide (ITO), silver nanowire (SNW), silver-stacked film (“AgStack”), ITO and silver alloys, or other transparent conductive materials.

As discussed further below, the embodiments described herein may use transparent antennas formed on transparent conductive mesh to take advantage of regions on the exterior of the electronic device for wireless charging. As noted above, these regions may include the lenses of electronic eyewear, the displays of wearable devices, the exterior surfaces of virtual reality devices, or other surfaces such as the windows of a building. The transparent antennas may be fabricated from transparent conductive meshes that may be made of metal (e.g., copper, silver, gold, ITO). Such conductive meshes may provide high conductivity and may appear transparent due to their low aperture ratio and visually imperceptible pitch size. By selectively removing the connectivity of specific regions of the mesh, antennas suitable for both near- and far-field power transfer may be provided, including inductive coils for near-field communication and charging, dipole and patch antennas for broad coverage, far-field power reception, and highly directional antenna arrays at millimeter-wave frequencies.

In one embodiment, a system may be provided. The system may include a substrate and a transparent conductive mesh disposed on the substrate. The transparent conductive mesh may include various traces formed therein, and these traces may be formed into antennas that are configured to wirelessly transfer and/or receive electrical power. In some cases, for example, the traces may form a loop antenna around the perimeter of an AR glasses lens or pair of lenses. Depending on its size and structure, the loop antenna formed in the transparent conductive mesh may be a near-field antenna or a far-field antenna.

For example, in some cases, different trace widths may be used when forming the antenna(s). These trace widths may range from 1-10 mm (or more). Wider trace widths may provide lower resistivity, leading to increased power transfer. Similarly, differences in the aperture ratio (which may include measures of mesh pitch and mesh width) may change how the antennas in the transparent conductive mesh operate. A smaller aperture ratio (e.g., the fraction of the mesh that is filled by metal) may provide better resistivity but may reduce transparency. Whereas a larger aperture ratio (e.g., where a smaller fraction of the mesh is filled by conductive material) may provide increased transparency, but more resistivity and, thus, lower power transfer.

In some cases, portions of the transparent conductive mesh may be removed from the substrate. As will be described further below, portions of the transparent conductive mesh may be removed to thereby form an antenna. In some examples, the removed portions of the transparent conductive mesh may be replaced with “dummy filling.” This dummy filling may look like transparent conductive mesh and may be made of the same material as the mesh that forms the antenna(s), but the dummy filling may not be electrically conductive due to small gaps or disconnections between mesh segments. Because the dummy filling may be placed in positions where the antenna is not, the dummy filling may ensure optical continuity while still providing the desired electrical properties (i.e., allowing the retained portions of mesh to function as an antenna).

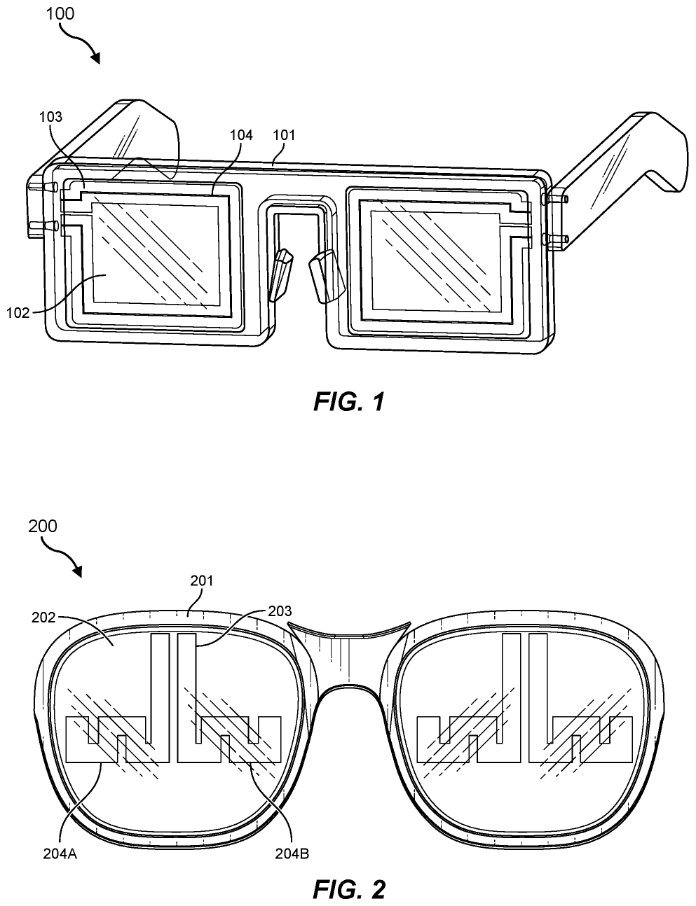

At least in some cases, the portions of the transparent conductive mesh that are removed may be removed according to a specified design that either partially or entirely avoids resonances in the conductive mesh. In such cases, the traces may be formed with a specified minimum width or may be formed in a specific shape or antenna architecture (e.g., loop, dipole, monopole, etc.). In other cases, the traces may be formed on the transparent conductive mesh having a specified minimum thickness. Additionally or alternatively, the traces may be formed on the transparent conductive mesh having a minimum specified level of pitch. This pitch level may be constant over the entire surface or may vary across the transparent conductive mesh. These embodiments each will be described in greater detail below with regard to FIGS. 1-8.

FIG. 1 illustrates a system 100 that includes at least one substrate 102. The substrate may be substantially any type of non-conductive material, including plastic, glass, ceramic, wood, or similar material. The substrate may include a larger surface area than other parts of the system 100. For instance, in cases where the system 100 is a pair of augmented reality (AR) glasses 101, the substrate 102 may be part of the lenses or may, itself, be the lenses of the AR glasses, which have substantially more surface area than the temple arms or nose bridge, for example. The substrate 102 may be formed in substantially any shape, size, or thickness, and may be positioned anywhere on the system. In FIG. 1, specifically, the substrate 102 may be part of the lenses of the AR glasses 101.

The system 100 may also include a transparent conductive material 103 disposed on at least a portion of the substrate 102. As noted above, the transparent conductive material 103 may include substantially any type of material that is both transparent or semi-transparent and electrically conductive. The transparent conductive material 103 may include transparent metal mesh, as well as other types of transparent conductors including indium tin oxide, silver nanowire, silver-stacked film, ITO-and-silver alloys, or other transparent conductive materials.

The system 100 may also include various electrical traces 104 formed into the transparent conductive material 103. The electrical traces 104 may be configured to conduct electrical power and may be shaped into one or more antennas that are configured to wirelessly transfer or receive electrical power. The electrical traces 104 may include portions of transparent conductive material 103 that is formed in the shape of a loop antenna, for example, or is formed in the shape of a dipole antenna, a patch antenna, or other type of antenna.

Indeed, the embodiments described herein may form substantially any type or shape of antenna. These antennas may be near-field antennas configured to operate at distances between around 1-5 cm (although the near-field antennas may operate in potentially longer ranges). This specified distance represents the operating distance between a wireless power receiving antenna and a wireless power transmitting antenna. The near-field antennas may be loop, monopole, dipole, array, patch, or other types of antennas. Additionally or alternatively, the antennas may form far-field antennas that are designed to operate at around 30 cm to 5 meters (or more). The far-field antenna may be a loop antenna (FIG. 1), a meandered dipole antenna (e.g., FIG. 2), a monopole antenna, an antenna array, a patch antenna, or other type of antenna.

FIG. 2, for instance, illustrates an embodiment 200 of a dipole antenna 203. The dipole antenna 203 may include two dipole arms 204A and 204B, which may each include meandering traces. The meandering traces may provide additional surface area that conducts more wireless power. The dipole antenna 203 may be made of a transparent conductive material. In some cases, the dipole antenna 203 may be made of transparent conductive mesh. The transparent conductive mesh may be arranged on a substrate such as lens 202 of AR glasses 201. The transparent conductive mesh may be invisible to the wearer of the AR glasses 201 but may be spread across the width and height of the lenses 202. This maximizes the surface area of the dipole antenna 203, while allowing other electronic components to be placed in the temple arms or nose bridge of the AR glasses 201.

In some cases, the dipole antenna 203 may be manufactured by first applying a transparent conductive mesh to some or most or all of the lens 202. The unwanted portions of transparent conductive mesh are then removed from the substrate, leaving transparent conductive mesh in the shape of a dipole antenna 203. The opposite ends of the dipole antenna may be connected to a power supply. In cases where the dipole antenna 203 is transmitting power wirelessly, the power may flow from the power supply (e.g., a battery or wired source) to the dipole antenna 203 and wirelessly to a receiving antenna and device. In cases where the dipole antenna 203 is receiving power wirelessly, the dipole antenna 203 may receive the power at the dipole arms 204A & 204B and transfer that power to a power store (e.g., a battery). In this manner, a transparent conductive mesh (or other transparent conductive material) may act as an antenna to receive or transmit power to or from other devices or power sources.

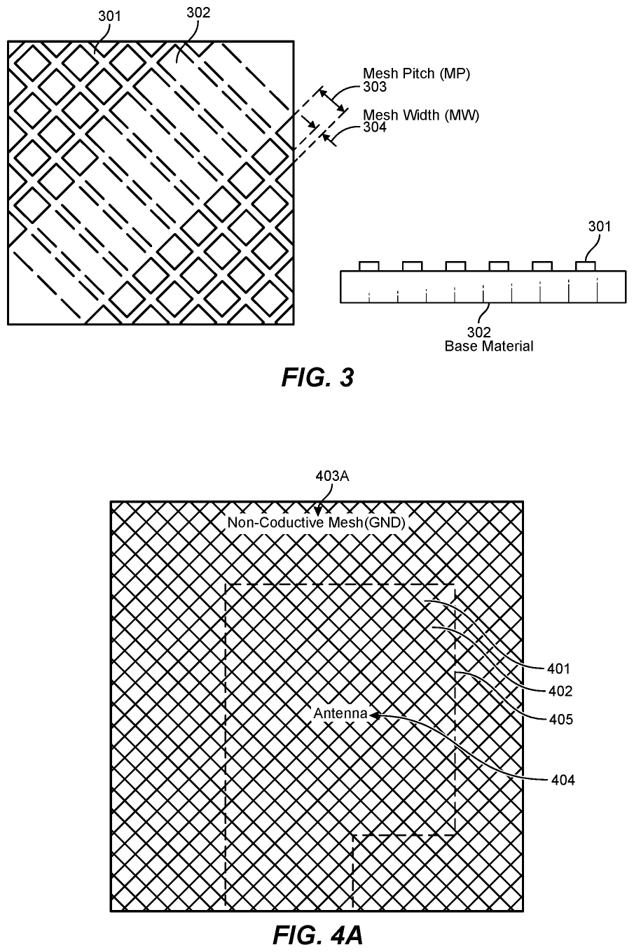

In cases where portions of the transparent conductive mesh are removed, those portions that were removed may be replaced with corresponding (or similarly shaped) portions of non-conductive transparent mesh. As shown in FIG. 3, a transparent conductive mesh may be formed from hundreds or thousands of interlinked sections or elements 301 that form a grid 302. The grid 302 may be substantially any size or shape and may include any number of elements 301 or sections of conductive material. The mesh elements may have a specified width 304 that indicates how wide the conductive elements are.

The mesh may also be formed at a specified pitch 303, which indicates how far apart the mesh elements are from each other. Smaller-pitched meshes are closer together and are more tightly bound, whereas larger-pitched meshes are further apart and are more loosely bound. Smaller-pitch meshes may be more efficient at conducting power but may be more inclined to create electromagnetic fields that could cause interference with other electronic components, whereas larger-pitch meshes may be worse at conducting power but may be less likely to cause interference with other electronic components.

In some cases, the electrical traces that are formed on the transparent conductive mesh (e.g., traces 104 of FIG. 1) may be formed with a specified minimum width. The width may vary based on the type of electronic device or the type of surface available or the amount of surface area available. In some embodiments, the width of the traces 104 may be between 2-10 mm or wider. In some cases, wider trace widths may result in lower resistivity and lower inductance and, thus, more efficient wireless power transfer between transmitter and receiver. Accordingly, at least in some cases, embodiments may seek to maximize the amount of surface area in the traces to maximize the efficiency of the power transfer (i.e., increase the number of watts that are wirelessly transferred).

The transparent conductive mesh material that forms the electrical traces 104 may also be manufactured at a specified minimum thickness. The indium tin oxide (ITO), silver nanowire (SNW), silver-stacked film, ITO-and-silver alloy, or other material used to form the transparent conductive mesh may be generated at a specified minimum or maximum thickness. In some cases, as noted above, a larger receiver may result in a more efficient power transfer. In some embodiments, the antenna formed from the traces may be a near-field antenna designed to provide short-range power transfer. In such cases, the near-field antenna may be disposed on the lens(es) of a pair of AR glasses. The traces forming the near-field antenna may be of sufficient thickness to provide a minimum power transfer efficiency. Increased trace thickness may result in an increased power transfer efficiency, while potentially losing some transparency. Whereas decreased thickness may result in increased transparency, while losing some power transfer efficiency. Increased transparency may lose conductivity per unit area in thickness.

Changes in width may have little to no effect on transparency. As such, at least in some embodiments, traces may be formed in a manner that is as wide and thin as possible to maintain transparency but is also thick enough to provide a minimum power transfer efficiency. Some embodiments may use thinner conductive mesh and may focus more on transparency, while other embodiments may use thicker conductive mesh and may focus more on power transfer efficiency. In some cases, the amount of power used by the electronic device may be taken into consideration when determining a width and/or thickness for the transparent conductive mesh used to form the traces for wireless power transfer. Moreover, the amount of available surface area may also be taken into consideration when determining an optimal width and/or thickness. For instance, augmented reality glasses lenses will typically have more surface area than a smartwatch, but less than a smartphone. Accordingly, this may be taken into consideration when optimizing trace size/thickness for a given mobile device.

Still further, the width and/or thickness of the traces formed using transparent conductive mesh may be varied depending on the type of antenna used for the wireless power transfer. For instance, as noted above, the antennas formed by the traces may be loop antennas, dipole antennas, microstrip antennas, patch antennas, array-based antennas, or other types of antennas. Each of these antennas may be used for near-field or far-field power transfer. Some types of antennas may use thicker or thinner traces, or wider or narrower traces depending on the antenna's architecture and the available amount of surface area on the electronic device. Accordingly, different devices with different amounts of available surface area and different types of antennas may implement different widths/thicknesses to optimize wireless power transfer specifically for a given electronic device.

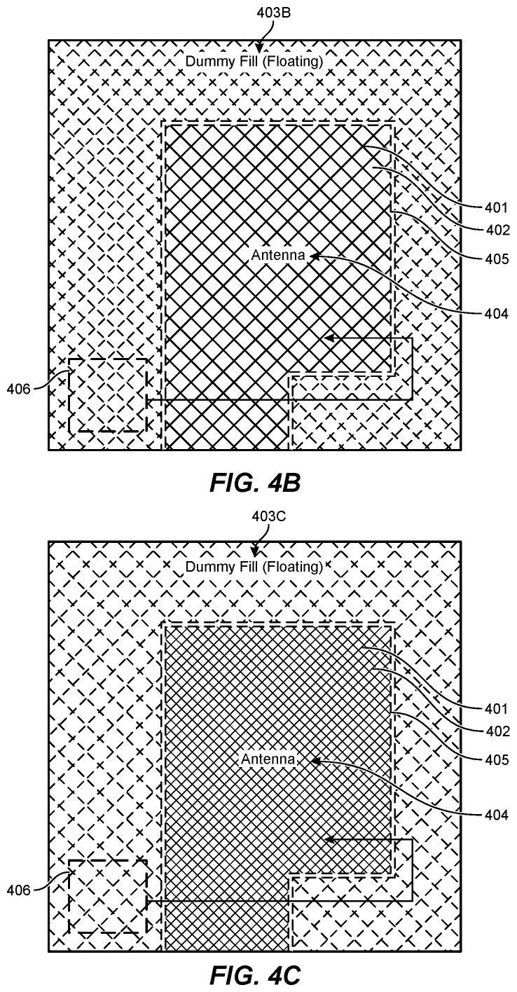

FIGS. 4A-4C illustrate embodiments in which a transparent conductive material (e.g., a transparent conductive mesh 401) may be implemented to wirelessly transfer power between a transmitter and a receiver. The transparent conductive mesh 401 may be applied to a substrate 402 such as plastic and may be applied in different sections of conductive mesh and non-conductive mesh. The non-conductive mesh 403A may have the same or similar optical properties to that of the conductive mesh 401. As such, the wearer of a pair of AR glasses, for example, may not be able to see transitions between mesh and no-mesh. Rather, the user may experience one solid, uniform layer of mesh that is devoid of optical irregularities or visible changes between sections of mesh and no-mesh.

In some embodiments, narrow sections of transparent conductive mesh may be removed to electrically isolate one portion of mesh from another. For instance, a narrow strip near or along the dotted line 405 may be removed to electrically isolate the antenna 404 from the grounded, non-conductive mesh 403A. In some cases, the narrow strip of separation on or near dotted line 405 may be of a specified width that is wide enough to electrically separate the antenna 404 from the non-conductive mesh 403A. This may allow the antenna 404 to conduct power as a receiving or transmitting antenna, while being electrically separated from grounded elements such as the non-conducting mesh 403A. In some cases, the removed portions (e.g., on or near dotted line 405) of the transparent conductive mesh 401 may be removed according to a specific design that is configured to avoid resonances at specific frequencies on the substrate 402.

FIG. 4B illustrates an embodiment in which the non-conductive transparent mesh (i.e., dummy fill) may include apertures of a different size. As described in relation to FIG. 3 above, the transparent conductive mesh may have a minimum specified aperture ratio that dictates how far each aperture is spaced from the other apertures in the mesh. In FIG. 4B, the dummy fill 403B may have a larger aperture ration than that in FIG. 4A. In this embodiment, the dummy fill may be floating in relation to the antenna 404 and the antenna feed 406. In FIG. 4C, the aperture ratio of the dummy fill 403C may be still larger and may differ from the aperture ratio of the transparent mesh that forms the antenna 404. As can be seen in FIG. 4C, the dummy fill has one or more broken connections among the mesh elements. As such, the dummy fill is not capable of acting as an antenna but ensures that there are no (or very minimal) changes in optical transparency across the lens or other surface.

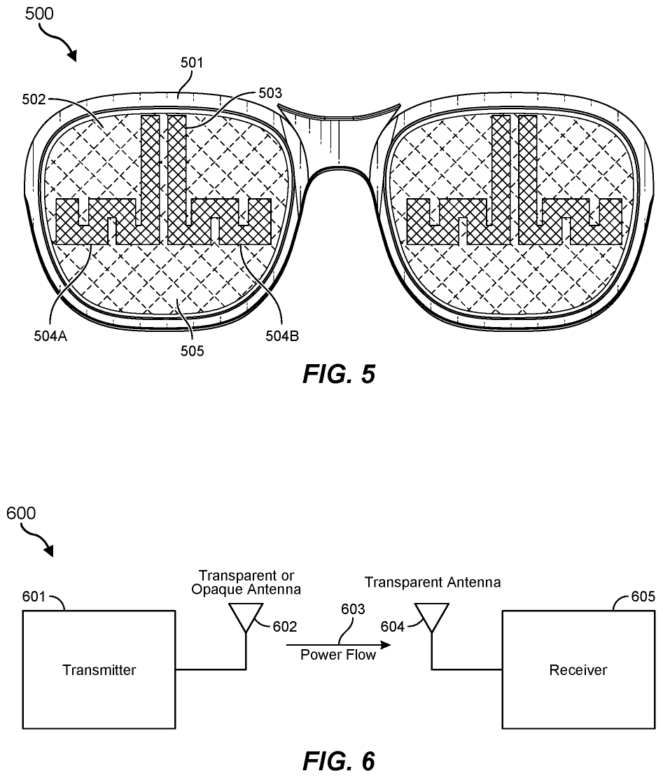

In some embodiments, the aperture ratio may vary across at least two different portions of the transparent conductive mesh. For instance, in embodiment 500 of FIG. 5, the aperture ratio of the transparent mesh 503 may vary within a single lens 502 (e.g., may be different on each side 504A/504B of the dipole antenna) or may have a mesh with one aperture ratio on one lens and a mesh with another aperture ratio on the other lens of the AR glasses 501. Still further, in some cases, the aperture ratio of the conductive transparent mesh 503 may be different than the aperture ratio of the non-conductive transparent mesh 505. In some cases, for example, the aperture ratio may be changed by changing the mesh pitch (e.g., 303 of FIG. 3).

In some embodiments, the mesh pitch 303 may be varied between 100 microns-1000 microns. At 100 microns, the transparent conductive mesh may have a relatively low sheet resistivity of, for example, 0.5 Ohm/sq, and an optical transparency between 90%-92%. At 1000 microns, the transparent conductive mesh may have a relatively high sheet resistivity of, for example, 10 Ohm/sq., and an optical transparency of 99%. Thus, a lower pitch may result in lower sheet resistivity and lower transparency, while a higher pitch may result in higher sheet resistivity and higher transparency. As with the widths and thicknesses described above, different mesh pitches or aperture ratios may be used to optimize power transfer in each specific mobile device implementation.

Each of the antenna implementations described above may be used as transmitters or as receivers when conducting wireless power. In FIG. 6, for example, a system 600 may be provided that implements a transmitter having a non-transparent (opaque) antenna or a transparent antenna 602, with a transparent antenna 604 at the receiver 605 to receive the power flow 603 from the transmitter 601. While the transmitter antenna 602 is shown as being transparent or opaque, it will be recognized that the receiver antenna 604 may also be transparent or opaque. In this manner, transparent conductive antennas may be implemented to wirelessly transfer power between power supplies and mobile electronic devices using a combination of transparent and/or opaque (e.g., wired) antennas.

In addition to the system described above, a corresponding mobile electronic device may be provided that includes: a substrate and a transparent conductive material disposed on at least a portion of the substrate, where the transparent conductive material includes one or more electrical traces formed therein, where the electrical traces are configured to conduct electrical power, and where the traces are shaped into one or more antennas that are configured to wirelessly transfer or receive electrical power.

A corresponding apparatus may also be provided that includes: a substrate and a transparent conductive material disposed on at least a portion of the substrate, where the transparent conductive material includes one or more electrical traces formed therein, where the electrical traces are configured to conduct electrical power, and where the traces are shaped into one or more antennas that are configured to wirelessly transfer or receive electrical power.

### Example Embodiments

Example 1. A system comprising: a substrate; and a transparent conductive material disposed on at least a portion of the substrate, wherein the transparent conductive material includes one or more electrical traces formed therein, the electrical traces being configured to conduct electrical power, and wherein the electrical traces are shaped into one or more antennas that are configured to wirelessly transfer or receive electrical power.

Example 2. The system of example 1, wherein at least one of the one or more antennas comprises a near-field antenna.

Example 3. The system of any of examples 1-2, wherein at least one of the one or more antennas comprises a far-field antenna or an antenna array.

Example 4. The system of any of examples 1-3, wherein the transparent conductive material comprises a transparent conductive mesh.

Example 5. The system of any of examples 1-4, wherein one or more portions of the transparent conductive mesh are removed from the substrate.

Example 6. The system of any of examples 1-5, wherein the removed portions of the transparent conductive mesh are replaced with corresponding portions of non-conductive transparent mesh.

Example 7. The system of any of examples 1-6, wherein the removed portions of the transparent conductive mesh are removed according to a specific design that is configured to avoid resonances on the substrate.

Example 8. The system of any of examples 1-7, wherein the one or more electrical traces that are formed on the transparent conductive mesh comprise a specified minimum width.

Example 9. The system of any of examples 1-8, wherein the one or more electrical traces that are formed on the transparent conductive mesh comprise a specified minimum thickness.

Example 10. The system of any of examples 1-9, wherein the transparent conductive mesh comprises a minimum specified aperture ratio that dictates how far each aperture is spaced from the other apertures in the transparent conductive mesh.

Example 11. The system of any of examples 1-10, wherein the aperture ratio varies across at least two different portions of the transparent conductive mesh.

Example 12. The system of any of examples 1-11, wherein the transparent conductive material comprises at least one of indium tin oxide (ITO), silver nanowire (SNW), silver-stacked film, or an ITO and silver alloy.

Example 13. A mobile electronic device comprising: a substrate; and a transparent conductive material disposed on at least a portion of the substrate, wherein the transparent conductive material includes one or more electrical traces formed therein, the electrical traces being configured to conduct electrical power, and wherein the electrical traces are shaped into one or more antennas that are configured to wirelessly transfer or receive electrical power.

Example 14. The mobile electronic device of example 13, wherein the substrate comprises one or more lenses in a pair of augmented reality glasses.

Example 15. The mobile electronic device of any of examples 13-14, wherein the substrate comprises a touchscreen of the mobile electronic device.

Example 16. The mobile electronic device of any of examples 13-15, wherein the one or more antennas formed by the traces comprise at least one of a loop antenna, a dipole antenna, a microstrip antenna, or an array-based antenna.

Example 17. The mobile electronic device of any of examples 13-16, wherein the transparent conductive material comprises a transparent conductive mesh, and wherein one or more portions of the transparent conductive mesh are removed from the substrate.

Example 18. The mobile electronic device of any of examples 13-17, wherein the removed portions of the transparent conductive mesh are replaced with corresponding portions of non-conductive transparent mesh.

Example 19. The mobile electronic device of any of examples 13-18, wherein the removed portions of the transparent conductive mesh are removed according to a specific design that is configured to avoid resonances on the substrate.

Example 20. An apparatus comprising: a substrate; and a transparent conductive material disposed on at least a portion of the substrate, wherein the transparent conductive material includes one or more electrical traces formed therein, the electrical traces being configured to conduct electrical power, and wherein the electrical traces are shaped into one or more antennas that are configured to wirelessly transfer or receive electrical power.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

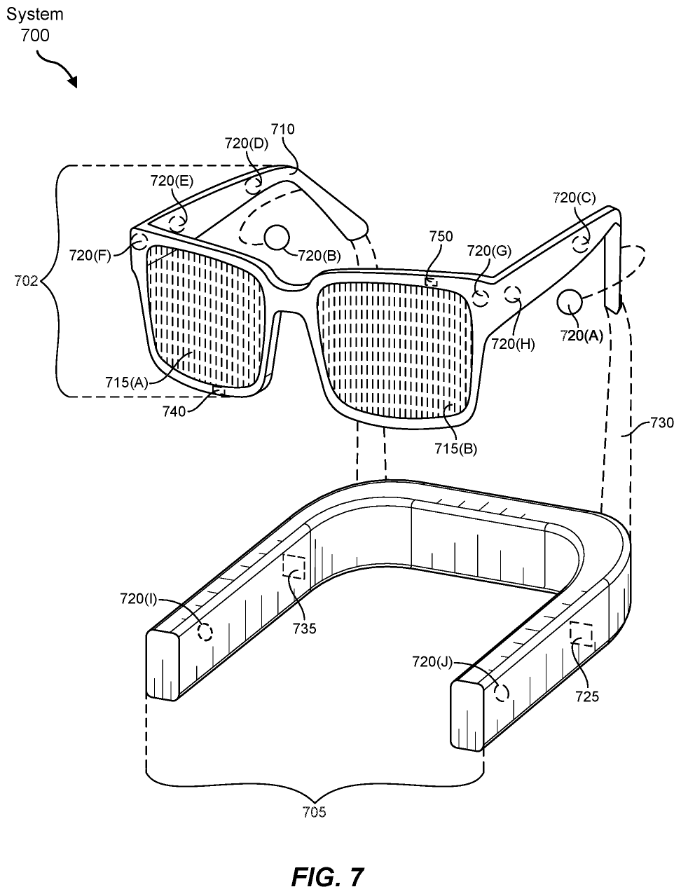

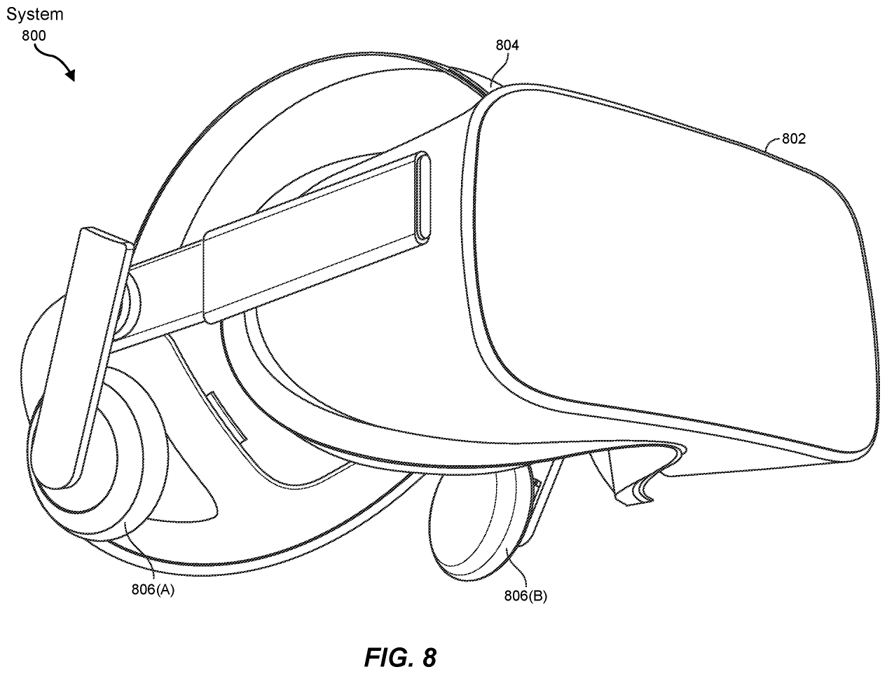

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(I) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), augmented-reality system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(1) and 720(J)) that are part of the microphone array (or potentially form their own microphone subarray). Neckband 705 may also include a controller 725 and a power source 735.

Acoustic transducers 720(1) and 720(J) of neckband 705 may be configured to detect sound and convert the detected sound into an electronic format (analog or digital). In the embodiment of FIG. 7, acoustic transducers 720(1) and 720(J) may be positioned on neckband 705, thereby increasing the distance between the neckband acoustic transducers 720(1) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium-ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

We claim:

1. A system comprising:
a substrate; and
a transparent conductive material disposed on at least a portion of the substrate,
wherein the transparent conductive material includes one or more electrical traces formed therein, the electrical traces being configured to conduct electrical power, and
wherein the electrical traces are shaped into one or more antennas that are configured to wirelessly transfer or receive electrical power.

2. The system of claim 1, wherein at least one of the one or more antennas comprises a near-field antenna.

3. The system of claim 2, wherein at least one of the one or more antennas comprises a far-field antenna or an antenna array.

4. The system of claim 1, wherein the transparent conductive material comprises a transparent conductive mesh.

5. The system of claim 4, wherein one or more portions of the transparent conductive mesh are removed from the substrate.

6. The system of claim 5, wherein the removed portions of the transparent conductive mesh are replaced with corresponding portions of non-conductive transparent mesh.

7. The system of claim 5, wherein the removed portions of the transparent conductive mesh are removed according to a specific design that is configured to avoid resonances on the substrate.

8. The system of claim 4, wherein the one or more electrical traces that are formed on the transparent conductive mesh comprise a specified minimum width.

9. The system of claim 4, wherein the one or more electrical traces that are formed on the transparent conductive mesh comprise a specified minimum thickness.

10. The system of claim 4, wherein the transparent conductive mesh comprises a minimum specified aperture ratio that dictates how far each aperture is spaced from other apertures in the transparent conductive mesh.

11. The system of claim 10, wherein the aperture ratio varies across at least two different portions of the transparent conductive mesh.

12. The system of claim 1, wherein the transparent conductive material comprises at least one of indium tin oxide (ITO), silver nanowire (SNW), silver-stacked film, or an ITO and silver alloy.

13. A mobile electronic device comprising:
a substrate; and
a transparent conductive material disposed on at least a portion of the substrate,
wherein the transparent conductive material includes one or more electrical traces formed therein, the electrical traces being configured to conduct electrical power, and
wherein the electrical traces are shaped into one or more antennas that are configured to wirelessly transfer or receive electrical power.

14. The mobile electronic device of claim 13, wherein the substrate comprises one or more lenses in a pair of augmented reality glasses.

15. The mobile electronic device of claim 13, wherein the substrate comprises a touchscreen of the mobile electronic device.

16. The mobile electronic device of claim 13, wherein the one or more antennas formed by the traces comprise at least one of a loop antenna, a dipole antenna, a microstrip antenna, or an array-based antenna.

17. The mobile electronic device of claim 13, wherein the transparent conductive material comprises a transparent conductive mesh, and wherein one or more portions of the transparent conductive mesh are removed from the substrate.

18. The mobile electronic device of claim 17, wherein the removed portions of the transparent conductive mesh are replaced with corresponding portions of non-conductive transparent mesh.

19. The mobile electronic device of claim 18, wherein the removed portions of the transparent conductive mesh are removed according to a specific design that is configured to avoid resonances on the substrate.

20. An apparatus comprising:
a substrate; and
a transparent conductive material disposed on at least a portion of the substrate,
wherein the transparent conductive material includes one or more electrical traces formed therein, the electrical traces being configured to conduct electrical power, and
wherein the electrical traces are shaped into one or more antennas that are configured to wirelessly transfer or receive electrical power.
